(19) United States
(12) Patent Application Publication
(10) Pub. No.: US 2010/0003179 A1
(43) Pub. Date: Jan. 7, 2010

(54) PROCESS FOR PREPARING METAL OXIDE POWDERS

(75) Inventors: Stipan Katusic, Bad Soden (DE); Guido Zimmermann, Bruehl (DE); Michael Kraemer, Schoeneck (DE); Heiko Gottfried, Schoeneck (DE); Peter Kress, Karlstein (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GMBH, ESSEN (DE)

(21) Appl. No.: 12/303,468

(22) PCT Filed: May 16, 2007
(86) PCT No.: PCT/EP07/54760

§ 371 Date: Dec. 4, 2008

(30) Foreign Application Priority Data
Jun. 13, 2006 (DE) 102006027334.6

(51) Int. Cl. C01F 17/00; C01G 9/02; C01F 5/14

(52) U.S. Cl. 423/263; 423/622; 423/636

(57) ABSTRACT

Process for preparing a metal oxide powder, in which starting materials are evaporated and oxidized, wherein a metal melt in the form of droplets and one or more combustion gases are fed to the evaporation zone of a reactor, where the metal melt is evaporated completely under nonoxidizing conditions, subsequently, the mixture flowing out of the evaporation zone is reacted in the oxidation zone of this reactor with a stream of a supplied oxygen-containing gas whose oxygen content is at least sufficient to oxidize the metal and the combustion gases completely.

The invention relates to a process for preparing metal oxide powders.

It is known that metal oxide powders can be prepared by means of pyrogenic processes. Commonly, metal compounds are evaporated and the vapours are converted to the oxides in a flame in the presence of oxygen. The disadvantage of this process lies in the availability of metal compounds whose evaporation temperature is only so great that they can be evaporated under economically viable conditions. These may, for example, be silicon tetrachloride, titanium tetrachloride or aluminium chloride, which are used to prepare the corresponding metal oxide powders on the industrial scale. Another disadvantage is that there are only a few materials for evaporators which are stable at high evaporation temperatures, often under corrosive conditions. This leads to the fact that the number of pyrogenic metal oxides preparable by this process is limited.

DE-A-10212680 and DE-A-10235758 disclose processes for preparing (doped) zinc oxide powders, in which zinc powder is first evaporated in a nonoxidizing atmosphere in an evaporation zone of a reactor, and then cooled in a nucleation zone to temperatures below the boiling point of zinc. In the nucleation zone, a dopant is optionally supplied in the form of an aerosol. Subsequently, the mixture leaving the nucleation zone is oxidized. The process is notable in that the nucleation step forms zinc species which impart particular properties to the later (doped) zinc oxide. In this process, there is, however, the risk of formation of cold surfaces and associated condensation of metal vapour. These processes are therefore suitable mainly for low metal vapour concentrations and therefore, in terms of economic viability, only of interest for the preparation of specific (doped) zinc oxide powders.

A reason for a further disadvantage of the known processes is that the zinc powder to be evaporated generally has a passivation layer of zinc oxide. This can lead to the fact that the evaporation of the powder proceeds incompletely and undesired grit is formed.

It is an object of the invention to provide a process for preparing metal oxide powders which does not have the disadvantages of the known processes. In particular, the process shall be performable inexpensively.

The invention provides a process for preparing a metal oxide powder, in which
oxidizable starting materials are evaporated in an evaporation zone of a reactor and oxidized in the vaporous state in an oxidation zone of this reactor,
the reaction mixture is cooled after the reaction and the pulverulent solids are removed from gaseous substances,
   in which
a metal melt in the form of droplets and one or more combustion gases are fed to the evaporation zone of the reactor, where the metal melt is evaporated completely under nonoxidizing conditions,
subsequently, the mixture flowing out of the evaporation zone is reacted in the oxidation zone of this reactor with a stream of a supplied oxygen-containing gas whose oxygen content is at least sufficient to oxidize the metal and the combustion gases completely.

The metal melt is preferably the melt of an individual metal. However, it is also possible to introduce a melt of a plurality of metals or else alloys. The metal melt introduced into the evaporation zone is preferably a melt of Ag, Al, As, Ba, Bi, Ca, Cd, Cu, Ga, Hg, In, Li, K, Mg, Mn, Na, Pb, Sb, Sn, Sr, Se, Te, Tl or Zn.

More preferably, a zinc melt can be used. It is also possible to use alloys of zinc and magnesium, zinc and aluminium, or zinc and manganese.

The technical means of preparing the dropletized metal melt are known to those skilled in the art and are described, for example, in Ullmann's Encyclopaedia of Industrial Chemistry, 5th Edition, Vol. A22, page 110 ff. The process can preferably be performed in such a way that the droplets of the metal melt are introduced as a spray together with an inert gas, for example nitrogen, or a reactive but nonoxidizing gas, for example steam. Particular preference is given to inert gases. The mean droplet size may preferably be less than 100 μm.

In the process according to the invention, the temperatures needed for the evaporation and oxidation can be provided by a flame which is formed by igniting a combustion gas with an oxygenous gas, where 0.5≦lambda≦1 in the evaporation zone and 1≦lambda≦10 in the oxidation zone.

The lambda value is defined as the quotient of the oxygen content of the oxygen-containing gas divided by the oxygen demand which is required for the complete oxidation of the combustion gas, of the metal and optionally of further metal compounds, in each case in mol/h.

Suitable combustion gases may be hydrogen, methane, ethane, propane, natural gas, acetylene, carbon monoxide or mixtures of the aforementioned gases. The temperature needed to evaporate the starting materials can be provided by virtue of a suitable selection of the aforementioned gases and the oxygen content of the flame. Preference is given to using hydrogen or mixtures with hydrogen.

Particular preference is given to an embodiment in which 0.65≦lambda≦0.95 in the evaporation zone and 1.3≦lambda≦6.5 in the oxidation zone.

The temperatures in the evaporation zone and oxidation zone are, independently of one another, generally 500° C. to 3000° C. They are guided principally by the physical properties, for example boiling point or vapour pressure, of the starting materials to be evaporated and to be oxidized.

The temperature can also be varied by means of an inert gas, for example nitrogen.

The mean residence time of the substances introduced into the evaporation zone and into the oxidation zone can be varied via the reactor dimensions and is therefore not limiting. An economically viable magnitude for the mean residence time in the evaporation zone and oxidation zone is, independently of one another, 5 ms to 30 s.

The temperatures and the residence times in evaporation zone and oxidation zone should, in the process according to the invention, be adjusted such that there is no significant sintering of the particles. The suitable conditions with regard to temperatures and residence times depend upon the metals and, if appropriate, upon further metal compounds, and should be determined in each case by experiments. The process is preferably performed so as to result in nanoscale particles having a mean diameter, based on primary particles, of less than 100 nm, more preferably of less than 50 nm.

The process according to the invention can be performed at different pressures, preferably at 200 mbar to 1100 mbar. Low pressures are advantageous owing to the resulting low evaporation temperatures.

The process according to the invention can also be performed in such a way that, in addition to the metal melt, one or more oxidizable metal compounds are introduced into the evaporation zone. The metal compound can preferably be introduced in solid form or in the form of a solution, more preferably an aqueous solution, or a dispersion, more preferably an aqueous dispersion.

The process according to the invention can also be performed such that, in addition to the metal melt and any metal compound introduced into the evaporation zone, one or more oxidizable metal compounds are introduced into the oxidation zone. The metal compound can preferably be introduced in solid form or in the form of a solution, more preferably of an organic solution, or a dispersion.

The metal component of the metal compounds introduced into the evaporation zone or the oxidation zone may be the same as the metal of the melt. The metal components of the metal compounds and the metal of the melt are, however, preferably different. The process according to the invention can more preferably be performed such that the melt of a metal and one or two metal compounds are used to form a binary or ternary mixed metal oxide powder.

The metal compounds used may preferably be chlorides, nitrates, sulphates, carbonates, C₁-C₁₂-alkoxides, C₁-C₁₂-carboxylates, acetylacetonates or carbonyls, with Ag, Al, As, Au, B, Ba, Be, Bi, Ca, Cd, Ce, Co, Cr, Cs, Cu, Er, Eu, Fe, Ga, Gd, Ge, Hf, In, K, La, Li, Mg, Mn, Mo, Na, Nb, Nd, Ni, P, Pb, Pd, Pm, Pr, Pt, Rb, Ru, Sb, Sc, Sm, Sn, Sr, Ta, Tb, Ti, Tl, Tm, V, W, Y, Yb, Zn, Zr as the metal component.

More preferably, C₁-C₄-alkoxides or the C₂-C₈-carboxylates of the metals Al, B, Ce, Fe, Ga, In, Li, Mg, Mn, Sb, Sn or Zn may be used.

C₁-C₄-Alkoxides include branched and unbranched, saturated alkoxides such as methoxides, ethoxides, isopropoxides, n-propoxides, n-butoxides, isobutoxides, sec-butoxides and tert-butoxides. C₂-C₈-Carboxylates include salts of branched and unbranched, saturated carboxylic acids such as acetic acid, propionic acid, butanoic acid, pentanoic acid, hexanoic acid, heptanoic acid, octanoic acid and 2-ethylhexanoic acid. C₁-C₄-Alcohols include branched and unbranched, saturated alcohols such as methanol, ethanol, isopropanol, n-propanol, n-butanol, isobutanol, sec-butanol and tert-butanol. C₂-C₈-Carboxylic acids include branched and unbranched, saturated carboxylic acids such as acetic acid, propionic acid, butanoic acid, pentanoic acid, hexanoic acid, heptanoic acid, octanoic acid and 2-ethylhexanoic acid.

Most preferably, C₂-C₈-carboxylates of the metals Al, Ce, Mn or Zn may be used dissolved in the corresponding C₂-C₈-caroboxylic acid.

When metal compounds are introduced into the process, it is advantageous when their proportion is not more than 25% by weight based on the sum of metal and metal component from a metal compound. The proportion of metal compounds is preferably not more than 10% by weight, more preferably not more than 5% by weight. The aim of the process according to the invention is to introduce maximum amounts of metal melt into the process instead of expensive metal compounds. The proportion of metal compounds used should therefore be low.

The metal compounds are preferably sprayed in. In this case, at least one one-substance nozzle at pressures up to 1000 bar can generate a very fine droplet spray, mean droplet size between <1-500 μm according to the pressure in the nozzle. In addition, at least one two-substance nozzle may be used at pressures up to 100 bar. The droplets can be generated by using one or more two-substance nozzles, in which case the gas used in the two-substance atomization may be reactive or inert.

The concentration of the metal compounds in the solutions may be varied within wide limits and depends, for example, upon the solubility of the metal compound used or the content of the metal component from the metal compound in the later mixed oxide powder. In general, the concentration of the metal compound, based on the solution, is 1 to 30% by weight.

In a particularly preferred embodiment of the process according to the invention, the metal melt used is a zinc melt, lambda is 0.65 to 0.95 in the evaporation zone and lambda is 1.5 to 6.5 in the oxidation zone.

The removal of the (mixed) oxide powder from the hot reaction mixture is generally preceded by a cooling process. This process can be implemented directly, for example by means of a quench gas such as air or nitrogen, or indirectly, for example by means of external cooling. The mixed oxide powder can be removed from gaseous substances by means of apparatus known to those skilled in the art, for example filters.

In a further particularly preferred embodiment,
the metal melt used is a zinc melt,
the solution of the metal compound introduced into the evaporation zone is an aqueous solution of an inorganic or organic metal compound having not more than 4 carbon atoms of aluminium, cerium or manganese as the metal component,
where the content of zinc is at least 80% by weight, based on the sum of zinc and the metal component from a metal compound,
lambda is 0.65 to 0.95 in the evaporation zone,
lambda is 1.5 to 6.5 in the oxidation zone.

In a further particularly preferred embodiment,
the metal melt used is a zinc melt,
the solution of the metal compound introduced into the oxidation zone is a solution of a C₂-C₈-carboxylate or C₁-C₄-alkoxide of aluminium, cerium or manganese as the metal component in C₁-C₄-alcohols and/or C₂-C₈-carboxylic acids,
where the content of zinc is at least 75% by weight, based on the sum of zinc and the metal component from a metal compound,
lambda is 0.65 to 0.95 in the evaporation zone,
lambda is 1.3 to 6.5 in the oxidation zone.

The invention further provides for the use of the metal oxide powder or mixed metal oxide powder prepared by the process according to the invention as a filler, as a support material, as a catalytically active substance, as a ceramic raw material, as a cosmetic and pharmaceutical raw material.

In the process according to the present invention, the metal component of the metal oxide is supplied to the evaporation in the form of a metal melt. According to whether the metal underlying the metal melt has been prepared in solid form by condensation of vapour or by spray-drying, the process according to the invention saves the process steps of evaporation and condensation/solidification or of melting and solidifying. This allows the capital costs, energy costs (heating and cooling) and assistants, for example nitrogen, etc. to be reduced or dispensed with entirely. In addition, the process according to the invention reduces the introduction of impurities.

### EXAMPLES

### Example 1

1000 g/h of a zinc melt are sprayed with the aid of a nitrogen-operated two-substance nozzle in an evaporation zone, where a hydrogen/air flame, hydrogen 8.1 m³ (STP)/h, air 15.4 m³ (STP)/h, burns. This evaporates the zinc.

Evaporation zone conditions: lambda: 0.77, mean residence time: 1000 msec, temperature: 1100° C., pressure: 980 mbar abs.

Subsequently, 30 m³ (STP)/h of oxidation air are added to the reaction mixture. Subsequently, the resulting powder is removed from the gas stream by filtration.

Oxidation zone conditions: lambda: 6.3, mean residence time: 100 msec, temperature: 800° C., pressure: 975 mbar.

To cool the hot reaction mixture, 120 m³ (STP)/h of quench air are added. Subsequently, the resulting powder is removed from the gas stream by filtration.

According to X-ray diffraction analysis, the powder is ZnO. The BET surface area is 24 m²/g.

### Example 2

1000 g/h of a zinc melt are, as in Example 1, transferred to an evaporation zone where a hydrogen/air flame, hydrogen 8.1 m³ (STP)/h, air 15.4 m³ (STP)/h, burns. This evaporates the zinc. Separately therefrom, 1000 g/h of a solution of manganese(II) acetate in water (concentration: 100 g/l) are sprayed by means of nitrogen into the evaporation zone (nozzle parameters: two-substance nozzle with nitrogen 3 m³ (STP)/h, bore ø 0.8 mm).

Evaporation zone conditions: lambda: 0.77, mean residence time: 1000 msec, temperature: 1100° C., pressure: 990 mbar.

Subsequently, 30 m³ (STP)/h of oxidation air are added to the reaction mixture.

Oxidation zone conditions: lambda: 6.3, mean residence time: 100 msec, temperature: 700° C., pressure: 985 mbar.

To cool the hot reaction mixture, 120 m³ (STP)/h of quench air are added. Subsequently, the resulting powder is removed from the gas stream by filtration.

According to X-ray diffraction analysis, the powder is a mixture of zinc oxide and manganese oxide.

It contains 96.8% by weight of ZnO and 3.2% by weight of MnO. The BET surface area is 25 m²/g.

### Example 3

1000 g/h of a zinc melt are, as in Ex. 1, transferred into an evaporation zone where a hydrogen/air flame, hydrogen 8.1 m³ (STP)/h, air 15.4 m³ (STP)/h, burns. This evaporates the zinc.

Evaporation zone conditions: lambda: 0.77, mean residence time: 1000 msec, temperature: 1100° C., pressure:. 980 mbar.

Subsequently, 30 m³ (STP)/h of oxidation air are added to the reaction mixture. Separately therefrom, an additional 1500 g/h of a solution of cerium(III) 2-ethylhexanoate in 2-ethylhexanoic acid (CeO₂ concentration: 120 g/kg) are sprayed into the oxidation zone by means of nitrogen (nozzle parameters: two-substance nozzle with nitrogen 3 m³/h, bore ø 0.8 mm).

Oxidation zone conditions: lambda: 0.77, mean residence time: 1000 msec, temperature: 1100° C., pressure: 975 mbar.

To cool the hot reaction mixture, 120 m³ (STP)/h of quench air are added. Subsequently, the resulting powder is removed from the gas stream by filtration.

According to X-ray fluorescence analysis (XFA), the powder contains 87.4% by weight of ZnO and 12.6% by weight of CeO₂. The BET surface area is 21 m²/g.

### Example 4 (Comparative Example)

As Example 1, except with lambda=1.5 in the evaporation zone.

According to X-ray diffraction analysis, the powder is ZnO. The BET surface area is 6 m²/g.

### Example 5

### As Example 3, except now 500 g/h of cerium octoate solution instead of 1500 g/h.

According to XFA, the powder contains 95.4% by weight of ZnO and 4.6% by weight of CeO₂. The BET surface area is 21 m²/g.

### Example 6

1000 g/h of a zinc melt are, as in Ex. 1, transferred into an evaporation zone where a hydrogen/air flame, hydrogen 8.1 m³ (STP)/h, air 15.4 m³ (STP)/h, burns. This evaporates the zinc. Separately therefrom, 1000 g/h of a solution of manganese(II) acetate in water (concentration: 100 g/l) is sprayed by means of nitrogen into the evaporation zone (nozzle parameters: two-substance nozzle with nitrogen 3 m³ (STP)/h, bore ø 0.8 mm).

Evaporation zone conditions: lambda: 0.77, mean residence time: 1000 msec, temperature: 1100° C., pressure: 990 mbar.

Subsequently, 30 m³ (STP)/h of oxidation air are added to the reaction mixture. Separately therefrom, an additional 500 g/h of a solution of cerium(III) 2-ethylhexanoate in 2-ethylhexanoic acid (CeO₂ concentration: 120 g/kg) are sprayed by means of nitrogen into the oxidation zone (nozzle parameters: two-substance nozzle with nitrogen 3 m³ (STP)/h, bore ø 0.8 mm).

Oxidation zone conditions: lambda: 0.77, mean residence time: 1000 msec, temperature: 1100° C., pressure: 975 mbar.

To cool the hot reaction mixture, 120 m³ (STP)/h of quench air are added. Subsequently, the resulting powder is removed from the gas stream by filtration.

According to XFA, the powder contains 92.5% by weight of ZnO, 4.5% by weight of CeO₂ and 3.0% by weight of MnO. The BET surface area is 22 m²/g.

### Example 7

As Example 1, except using a magnesium melt instead of the zinc melt.

The powder is MgO. The BET surface area is 52 m²/g.

### Example 8

### As Example 1, except using a 90/10 zinc-magnesium melt instead of the zinc melt.

According to XFA, the powder contains 87.1% by weight of ZnO and 12.9% by weight of MgO. The BET surface area is 28 m²/g.

TABLE
Feedstocks, amounts used and reaction conditions

| | Example | | | | | | | | | |
|---|---|---|---|---|---|---|---|---|---|---|
| | | | | | | 4 | | | | |
| | | | 1 | 2 | 3 | (comp.) | 5 | 6 | 7 | 8 |
| Evaporation | Metal melt flow | g/h | Zn | Zn | Zn | Zn | Zn | Zn | Mg | ZnMg*) |
| zone | rate | | 1000 | 1000 | 1000 | 1000 | 1000 | 1000 | 1000 | 1000 |
| | Metal compound | g/h | — | Manganese | — | — | — | Manganese | — | — |
| | flow rate | | | acetate | | | | acetate | | |
| | | | — | 1000 | — | — | — | 1000 | — | — |
| | Combustion flow | m³ | H₂ | H₂ | H₂ | H₂ | H₂ | H₂ | H₂ | H₂ |
| | rate | (STP)/h | 8.1 | 8.1 | 8.1 | 8.1 | 8.1 | 8.1 | 8.1 | 8.1 |
| | Air | m³ | 15.4 | 15.4 | 15.4 | 30 | 15.4 | 15.4 | 15.4 | 15.4 |
| | | (STP)/h | | | | | | | | |
| | Lambda | | 0.77 | 0.75 | 0.77 | 1.5 | 0.77 | 0.75 | 0.72 | 0.76 |
| | Mean residence | ms | 1000 | 1000 | 1000 | 1000 | 1000 | 1000 | 1000 | 1000 |
| | time | | | | | | | | | |
| | Temperature | ° C. | 1100 | 1100 | 1100 | 1100 | 1100 | 1100 | 1100 | 1100 |
| Oxidation | Oxidation air | m³ | 30 | 30 | 30 | 15 | 30 | 30 | 30 | 30 |
| zone | | (STP)/h | | | | | | | | |
| | Metal compound | g/h | — | — | Cerium | — | Cerium | Cerium | — | — |
| | flow rate | | | | octoate | | octoate | octoate | | |
| | | | — | — | 1500 | — | 1500 | 1500 | — | — |
| | Lambda | | 6.3 | 6.3 | 2.5 | —**) | 2.5 | 2.5 | 4.9 | 4.4 |
| | Mean residence | ms | 100 | 100 | 100 | 100 | 100 | 100 | 100 | 100 |
| | time | | | | | | | | | |
| | Temperature | ° C. | 700 | 700 | 700 | 700 | 700 | 700 | 700 | 700 |
| Quench zone | Quench gas | | 120 | 120 | 120 | 120 | 120 | 120 | 120 | 120 |
| | Temperature | ° C. | 200 | 200 | 200 | 200 | 200 | 200 | 200 | 200 |

*)90/10 Zn/Mn;
**)not defined;

1. Process for preparing a metal oxide powder, in which
oxidizable starting materials are evaporated in an evaporation zone of a reactor and oxidized in the vaporous state in an oxidation zone of this reactor,
the reaction mixture is cooled after the reaction and the pulverulent solids are removed from gaseous substances,
characterized in that
a metal melt in the form of droplets and one or more combustion gases are fed to the evaporation zone of a reactor, where the metal melt is evaporated completely under nonoxidizing conditions,
subsequently, the mixture flowing out of the evaporation zone is reacted in the oxidation zone of this reactor with a stream of a supplied oxygen-containing gas whose oxygen content is at least sufficient to oxidize the metal and the combustion gases completely.

2. The process according to claim 1, wherein the metal melt introduced into the evaporation zone is a melt of Ag, Al, As, Ba, Bi, Ca, Cd, Cu, Ga, Hg, In, Li, K, Mg, Mn, Na, Pb, Sb, Sn, Sr, Se, Te, TI or Zn.

3. The process according to claim 1, wherein the temperatures needed for evaporation and oxidation are provided by a flame which is formed by ignition of a combustion gas with an oxygenous gas, where 0.5≦lambda≦1 in the evaporation zone and 1≦lambda≦10 in the oxidation zone.

4. The process according to claim 1, wherein the pressure in the reactor is 200 to 1100 mbar.

5. The process according to claim 1, wherein oxidizable metal compounds are introduced into the evaporation zone and/or the oxidation zone in addition to the metal melt.

6. The process according to claim 5, wherein the metal compound used is a chloride, a nitrate, a sulphate, a carbonate, a C₁-C₁₂-alkoxide, a C₁-C₁₂-carboxylate, an acetylacetonate and/or a carbonyl, with Ag, Al, As, Au, B, Ba, Be, Bi, Ca, Cd, Ce, Co, Cr, Cs, Cu, Er, Eu, Fe, Ga, Gd, Ge, Hf, In, K, La, Li, Mg, Mn, Mo, Na, Nb, Nd, Ni, P, Pb, Pd, Pm, Pr, Pt, Rb, Ru, Sb, Sc, Sm, Sn, Sr, Ta, Th, Ti, Tl, Tm, V, W, Y, Yb, Zn, Zr as the metal component.

7. The process according to claim 5, wherein the proportion of metal compounds is not more than 25% by weight, based on the sum of metal and metal component from a metal compound.

8. The process according to claim 1 wherein
the metal melt used is a zinc melt,
lambda is 0.65 to 0.95 in the evaporation zone,
lambda is 1.5 to 6.5 in the oxidation zone.

9. The process according to claim 1, wherein
the metal melt used is a zinc melt,
the solution of the metal compound introduced into the evaporation zone is an aqueous solution of an inorganic or organic metal compound having not more than 4 carbon atoms of aluminium, cerium or manganese as the metal component,
where the content of zinc is at least 75% by weight, based on the sum of zinc and the metal component from a metal compound,
lambda is 0.65 to 0.95 in the evaporation zone,
lambda is 1.5 to 6.5 in the oxidation zone.

10. The process according to claim 1, wherein
the metal melt used is a zinc melt,
the solution of the metal compound introduced into the oxidation zone is a solution of a C₂-C₈-carboxylate or C₁-C₄-alkoxide of aluminium, cerium or manganese as the metal component in C₁-C₄-alcohols and/or C₂-C8-carboxylic acids,
where the content of zinc is at least 75% by weight, based on the sum of zinc and the metal component from a metal compound,
lambda is 0.65 to 0.95 in the evaporation zone,
lambda is 1.3 to 6.5 in the oxidation zone.

11. A filler, a support material, a catalytically active substance, a ceramic raw material, a cosmetic or a pharmaceutical raw material comprising the metal oxide powder prepared by the process according to claim 1.
